(19) United States
(12) Patent Application Publication
(10) Pub. No.: US 2026/0036436 A1
(43) Pub. Date: Feb. 5, 2026

(54) METHOD AND SYSTEM FOR IDENTIFYING A PARKING LOT RELATIVE TO A POINT OF INTEREST

(71) Applicant: GRABTAXI HOLDINGS PTE. LTD., Singapore (SG)

(72) Inventors: Xi LIN, Singapore (SG); Chen LIANG, Singapore (SG); Sien Yi TAN, Singapore (SG); Wenjie XU, Chaoyang, Beijing (CN)

(21) Appl. No.: 19/099,217

(22) PCT Filed: Jul. 24, 2023
(86) PCT No.: PCT/SG2023/050513

§ 371 Date: Jan. 28, 2025

(30) Foreign Application Priority Data
Aug. 8, 2022 (SG) 10202250688C

(51) Int. Cl. G01C 21/36; G08G 1/14

(52) U.S. Cl. CPC G01C 21/3685; G08G 1/14

(57) ABSTRACT

The present disclosure provides methods and systems for identifying a parking lot relative to a place of interest (POI), In some examples, there is provided a method comprising: detecting, from a plurality of data points, one or more data points that are indicative of a parking action in a parking lot, the plurality of data points representing movement along a route from a starting location to a destination location, each data point indicating a location, associating a first set of one or more of the detected data points with a POI based on a proximity of the indicated location of each of the one or more detected data points relative to a location of the POI, the POI being the starting location or the destination location; associating a second set of one or more of the detected data points with one or more geographical areas in proximity with the POI, the association based on a proximity of the indicated location of each of the one or more detected data points relative to the one or more geographical areas, and identifying the one or more parking lots relative to the POI from the first or second set of detected data points based on a comparison of a number of the first set of detected data points with a threshold.

### FIELD OF INVENTION

The present disclosure relates broadly, but not exclusively, to methods and systems for identifying a parking lot relative to a point of interest (POI).

### BACKGROUND

Parking lot detection is important in urban mobility. A strong knowledge of parking lot locations provides motorists with a smooth driving experience and helps them with their route plannings. For example, a motorist may prefer one restaurant over another if he or she knows that there is a parking lot associated with this restaurant and that this parking lot is conveniently accessible.

However, various parking lot detection techniques that are used in the industry today (for example, used by ride-hailing platforms) generally are heavily dependent on volume of data and do not consider scenarios when such data is sparse. For example, techniques that utilize vehicle probe data may not include parking points of places that are not so popular. Similarly, an aerial vehicle may not be able to cover all areas of a city, let alone indoor ones.

A need therefore exists to provide methods and systems that seek to overcome or at least minimize the above mentioned challenges.

### SUMMARY

According to a first aspect of the present disclosure, there is provided a method for identifying one or more parking lots relative to a POI, the method comprising: detecting, from a plurality of data points, one or more data points that are indicative of a parking action in a parking lot, the plurality of data points representing movement along a route from a starting location to a destination location, each data point indicating a location; associating a first set of one or more of the detected data points with a POI based on a proximity of the indicated location of each of the one or more detected data points relative to a location of the POI, the POI being the starting location or the destination location; associating a second set of one or more of the detected data points with one or more geographical areas in proximity with the POI, the association based on a proximity of the indicated location of each of the one or more detected data points relative to the one or more geographical areas; and identifying the one or more parking lots relative to the POI from the first or second set of detected data points based on a comparison of a number of the first set of detected data points with a threshold.

According to a second aspect of the present disclosure, there is provided a system for identifying one or more parking lots relative to a POI, comprising: at least one processor; and at least one memory including computer program code; the at least one memory and the computer program code configured to, with the at least one processor, cause the system at least to: detect, from a plurality of data points, one or more data points that are indicative of a parking action in a parking lot, the plurality of data points representing movement along a route from a starting location to a destination location, each data point indicating a location; associate a first set of one or more of the detected data points with a POI based on a proximity of the indicated location of each of the one or more detected data points relative to a location of the POI, the POI being the starting location or the destination location; associate a second set of one or more of the detected data points with one or more geographical areas in proximity with the POI, the association based on a proximity of the indicated location of each of the one or more detected data points relative to the one or more geographical areas; and identify the one or more parking lots relative to the POI from the first or second set of detected data points based on a comparison of a number of the first set of detected data points with a threshold.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for identifying one or more parking lots relative to a POI according to various embodiments of the present disclosure.

FIG. 2 is a schematic diagram of an identification server, according to various embodiments of the present disclosure.

FIG. 3 depicts an overview of how one or more parking lots relative to a POI may be identified according to various embodiments.

FIG. 4 illustrates an example flow diagram of a method for identifying one or more parking lots relative to a POI according to various embodiments.

FIG. 5 illustrates an example flow diagram for a clustering technique according to various embodiments.

FIG. 6 illustrates an example flow diagram for identifying a centroid relative to a POI according to an embodiment.

FIG. 7 illustrates an example flow diagram for identifying a centroid relative to a POI according to another embodiment.

FIG. 8A is a schematic block diagram of a general purpose computer system upon which the identification server of FIG. 2 can be practiced.

FIG. 8B is a schematic block diagram of a general purpose computer system upon which a combined transaction processing and identification server of FIG. 1 can be practiced.

FIG. 9 shows an example of a computing device to realize the transaction processing server shown in FIG. 1.

FIG. 10 shows an example of a computing device to realize the identification server shown in FIG. 1.

FIG. 11 shows an example of a computing device to realize a combined transaction processing and identification server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (of a product or service) and a provider device (of the product or service). For example, a platform may offer a service offered by a provider such as a ride, delivery, online shopping, insurance, and other similar services to a requestor. The requestor can typically access the platform via a website, an application, or other similar methods.

A place of interest (POI) is a place or location that a user may indicate or search for in a transport or delivery booking service. The POI may be a place at which the user may be interested in going or delivering something. It may also be a location at which the user wants to be picked up by a driver (e.g. a pick up point) or at which a delivery person is to retrieve an item for the user. There may be various drop off points (e.g. places where a user may alight after a ride, or deliver an item) or pick up points (e.g. places where a user may board a vehicle or receive an item that is to be delivered) associated with a POI which a user may be able to indicate or search in a transport or delivery booking service. In a request for a ride or delivery that may be sent from the user to the transport or delivery booking service, the POI at which the user wants to begin the ride or start the delivery may be indicated as a starting location, while the POI at which the user may be interested in going or delivering something may be indicated as a destination location.

A data point represents a time instance of a movement along a route (e.g. a route taken during a ride or delivery) from a starting location to a destination location, such that movement along the route may be represented by a plurality of data points. Each data point may be derived from probe data which is generated by, for example, monitoring the position of individual vehicles or users (i.e., probes) over space and time. The monitoring may be based on GPS signals that are emitted at a time instance by one or more vehicles that are utilized for the movement along the route, or by a device (e.g. a GPS device, mobile device, or other similar device) of a user associated in the movement along the route. Each data point may indicate a location (e.g. latitudinal and longitudinal (lat-lon) coordinates), velocity, time-stamp, and other similar information relating to the time instance represented by the data point.

Based on the indicated information (e.g. location, velocity, etc), it is possible to infer a location of a parking lot (e.g. a location in which a vehicle such as a car, motorcycle or other similar vehicle may be parked) by discerning a parking action (e.g. change in velocity based on one or more data points, a series of data points that are geospatially close to one another, or other similar patterns). Clustering may be performed on such data points that are indicative of parking action. Cluster analysis or clustering is a task of grouping a set of objects in such a way that objects in the same group (called a cluster) are more similar (in some sense) to each other than to those in other groups (clusters). Techniques for performing cluster analysis include DBSCAN, K-means, and other similar techniques. In the present disclosure, one or more data points may be chosen based on proximity of each data point location with the location of a POI or a geographical area, and these data points may be grouped into one or more clusters based on proximity of each data point with one another, as well as location information contained in the data points e.g., data points within each cluster having the same location information. A centroid (e.g. a centre of a cluster) is a vector that contains one number for each variable (e.g. data point) in a cluster, where each number is the mean of a variable for the observations in that cluster. The centroid can be thought of as the multi-dimensional average of the cluster. This centroid may be determined for the cluster via centroid cluster analysis, and may be considered to be indicative of a location of a parking lot.

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g. a person who requests for a product or service) or a provider (e.g. a person who provides the requested product or service to the requestor).

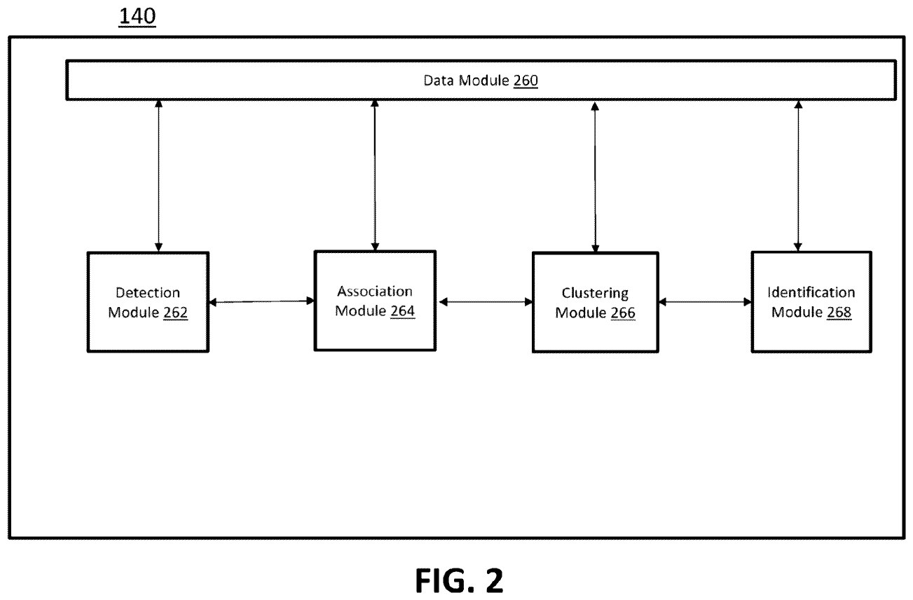

In at least some embodiments, an identification server is a server that hosts software application programs for identifying one or more parking lots relative to a location. The identification server may be implemented as shown in schematic diagram 200 of FIG. 2 for identifying one or more parking lots relative to a location.

In at least some embodiments, a transaction processing server is a server that hosts software application programs for processing payment transactions for, for example, a travel-ordination request, purchasing of a good or service by a user, and other similar services. The transaction processing server communicates with any other servers (e.g., a identification server) concerning processing payment transactions relating to the purchasing of the good or service, such as a travel co-ordination request (which may be referred to interchangeably as a request for a ride). For example, data relating to a request message such as a request for a ride (e.g. date, time, a starting location, a destination location, and other similar data) may be provided to the identification server and processed to locate drivers (e.g. ride providers) that are in proximity to the starting location. The transaction processing server may use a variety of different protocols and procedures in order to process the payment and/or travel co-ordination requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g. a company or organization) which operates to process transaction requests and/or travel co-ordination requests e.g. pair a provider of a travel co-ordination request to a requestor of the travel co-ordination request. The transaction processing server may include one or more computing devices that are used for processing transaction requests and/or travel co-ordination requests.

In at least some embodiments, a transaction account is an account of a user who is registered at a transaction processing server. The user can be a customer, a merchant providing a product for sale on a platform and/or for onboarding the platform, a hail provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “detecting”, “grouping”, “determining”, “associating”, “selecting”, “calculating”, “processing”, “storing”, “indicating”, “discerning”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Parking lot detection techniques generally fall into several categories. The first category considers such detection on a small scale, such as identifying empty parking spots with a single vehicle. Typically, each vehicle is associated with a set of sensors and programs which can detect whether a parking spot is empty or occupied when that vehicle is near to the parking spot.

In the second category, aerial imagery is used for outdoor parking lot detections. In such work, an aerial vehicle (e.g., unmanned planes) is used to collect the images, and detection is performed on these images. However, a disadvantage is that they are only able to detect outdoor parking lots, but not indoor ones.

The third category relates to detection of parking lots using probe data. In this case, parking lots are detected using the trajectories of vehicle trips. Each trajectory contains a series of points (e.g. probe points or data points), where each point contains spatiotemporal information such as the time at which that point is sampled, as well as its associated GPS coordinates. Detection is typically done by considering all transition points during a trip where a driver is likely to have parked his or her car, and then performing clustering analysis on these points.

However, while methods using probe data are able to detect both indoor and outdoor parking lots, they are not able to tell which is typically preferred or accessible by drivers. For example, a parking lot that is geographically close to a restaurant may not be popular among drivers because it involves climbing up long flights of stairs. In another example, a parking lot may be one that is privately owned, e.g., by a company, and cannot be considered for general usage. Furthermore, these approaches are heavily dependent on the volume of data and do not consider scenarios when such data is sparse. For example, vehicle probe data may not include parking points of places that are not so popular. Similarly, an aerial vehicle may not be able to cover all areas of a city, let alone indoor ones.

In the present disclosure, an approach is presented that addresses the above-mentioned issues. Vehicle transition points from probe data as well as collective information of drivers over a large period of time and scale are leveraged to identify the popular parking lots that drivers typically park at. This approach is advantageously able to infer parking lots associated with a location or POI even in the presence of probe data sparsity.

In the present disclosure, an end-to-end approach is proposed that detects POI-specific popular parking lots, while addressing the above-mentioned issues. To this end, detections of transition points for all probe traces (e.g. detection of data points) are first performed during movement along a route from a starting location to a destination location of a trip. A transition point may be defined as a location when a driver changes his or her medium of travel during the trip, for example from motorcycle to on-foot. These points are also where drivers are more likely to have parked their vehicles. With these transition points, a location-specific clustering may be performed. The key idea is that clustering is performed only on the transition points where the location is the starting location or destination location of the trip. Doing so advantageously allows identification of valid parking lot candidates that drivers used during the trip to and/or from the location. It also provides a measure of popularity of such parking lot candidates.

Since a location may not always have sufficient transition points to guarantee a good clustering, a hierarchical parking lot replacement technique may be performed to resolve this issue. The key idea is if a location does not have sufficient transition points, clustering is done instead based on a geographical area or neighbouring geographical area (e.g. geohash or neighbouring geohash) that this location is on. The rationale is that POIs that are within the same geographical area are more likely to share the same parking lots. As such, parking lots derived based on geohash-specific transition points may be a reliable fallback in the case of POI-specific transition data sparsity.

Additionally, a variation of this solution may be utilized. Specifically, instead of focusing clustering on POI-specific transition points, clustering may be performed on those of other POIs (e.g. POIs besides the starting location and destination location) or geospatial-entities, such as 1) buildings or 2) streets. Doing so not only resolves transition point sparsity during clustering, but also remove duplicates in the detection, i.e., two POIs in the same building sharing the same parking lots, while maintaining a finer granularity than geohash.

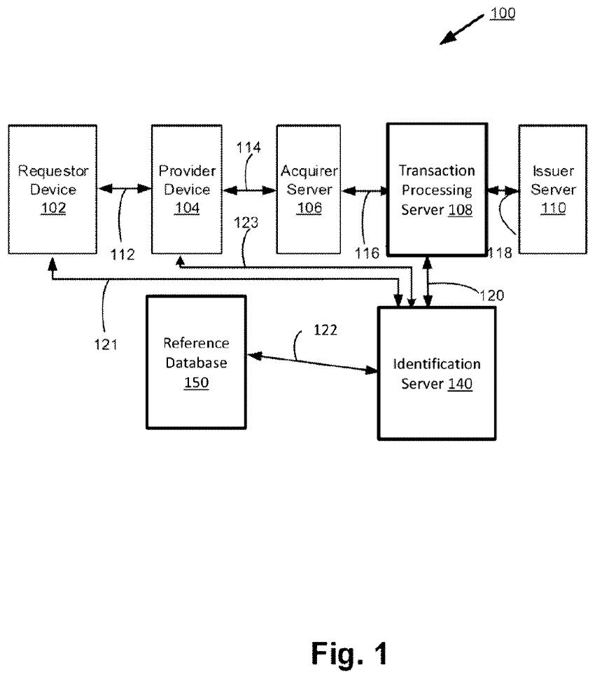

FIG. 1 illustrates a block diagram of an example system 100 for identifying one or more parking lots relative to a POI. In some embodiments, the system 100 enables a payment transaction for a good or service, and/or a request for a ride or delivery of a physical item (e.g. one or more food items or a parcel) between a requestor and a provider.

The system 100 comprises a requestor device 102, a provider device 104, an acquirer server 106, a transaction processing server 108, an issuer server 110, an identification server 140 and a reference database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the identification server 140 via a connection 121, wherein the identification server 140 may be configured to receive information relating to movement along a route from a starting location to a destination location (e.g. probe data) from the requestor device 102. The connection 121 may be via a network (e.g., the Internet). The requestor device 102 may also be connected to a cloud that facilitates the system 100 for identifying one or more parking lots relative to a POI. For example, the requestor device 102 can send a signal or data to the cloud directly via a wireless connection (e.g., via NFC communication, Bluetooth, etc.) or over a network (e.g., the Internet).

The provider device 104 is in communication with the requestor device 102 as described above, usually via the transaction processing server 108, and may be associated with a provider of a ride or delivery (e.g. a driver responding to the request for the ride or delivery). The provider device 104 is, in turn, in communication with an acquirer server 106 via a connection 114. The provider device 104 is also in communication with the identification server 140 via a connection 123, wherein the identification server 140 may be configured to receive information relating to movement along a route from a starting location to a destination location (e.g. probe data) from the provider device 104. The connections 114 and 123 may be via a network (e.g., the Internet). The provider device 104 may also be connected to a cloud that facilitates the system 100 for identifying one or more parking lots relative to a POI. For example, the provider device 104 can send a signal or data to the cloud directly via a wireless connection (e.g., via NFC communication, Bluetooth, etc.) or over a network (e.g., the Internet).

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the identification server 140 via a connection 120. The connection 120 may be over a network (e.g., a local area network, a wide area network, the Internet, etc.). In one arrangement, the transaction processing server 108 and the identification server 140 are combined and the connection 120 may be an interconnected bus.

The identification server 140, in turn, is in communication with the reference database 150 via respective connection 122. The connection 122 may be over a network (e.g., the Internet). The identification server 140 may also be connected to a cloud that facilitates the system 100 for identifying one or more parking lots relative to a POI. For example, the identification server 140 can send a signal or data to the cloud directly via a wireless connection (e.g., via NFC communication, Bluetooth, etc.) or over a network (e.g., the Internet).

The reference database 150 may comprise data that is utilized by the identification server 140 for identifying one or more parking lots relative to a POI. For example, probe data obtained from one or more trip trajectories (e.g. each trip trajectory comprising movement along a route from a starting location to a destination location) in a road network and/or map may be processed and stored as data points in the reference database 150, wherein each trip trajectory may comprise a plurality of data points. Each data point represents a time instance of movement along a route, and may indicate a location (e.g. lat-lon coordinates), velocity, time-stamp, and other similar information relating to the time instance represented by the data point. The reference database 150 may also comprise data relating to maps (e.g. Karta Map™), as well as location information relating to POIs, geographical areas, buildings, road networks, previously identified parking lots, and other similar entities that may facilitate identifying one or more parking lots relative to a POI. In an implementation, the reference database 150 may be combined with the identification server 140. In an example, the reference database 150 may be managed by an external entity.

The identification server 140 may be configured to detect, from a plurality of data points, one or more data points that are indicative of a parking action in a parking lot, the plurality of data points representing movement along a route from a starting location to a destination location, each data point indicating a location. The identification server 140 may then be configured to associate a first set of one or more of the detected data points with a POI based on a proximity of the indicated location of each of the one or more detected data points relative to a location of the POI, the POI being the starting location or the destination location. The identification server 140 may then be configured to associate a second set of one or more of the detected data points with one or more geographical areas in proximity with the POI, the association based on a proximity of the indicated location of each of the one or more detected data points relative to the one or more geographical areas. The identification server 140 may then be configured to identify one or more parking lots relative to the POI from the first or second set of detected data points based on a comparison of a number of the first set of detected data points with a threshold.

Detecting the one or more data points may be based on determining one or more consecutive data points that are geospatially close to each other based on the indicated location. Each data point may represent a time instance of the movement along the route and further indicate a velocity of the represented time instance, and detecting the one or more data points may be based on determining one or more data points that correspond to a change of velocity based on the indicated velocity.

In an implementation, there may be more than one reference databases, in which the identification server 140 may be configured to determine which database to use for each step during the process of identifying one or more parking lots relative to the POI. Alternatively, one or more modules may store the above-mentioned data instead of the reference database 150, wherein the module may be integrated as part of the identification server 140 or external from the identification server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send data relating to a requested ride or delivery, and for the provider device 104 to send data relating to acceptance or rejection of a ride or delivery request, in response to an enquiry shown on the GUI running on the respective API. It is also possible for the requestor device 102 and/or the provider device 104 to send probe data relating to a ride or delivery, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The identification server 140 is associated with an entity (e.g. a company or organization or moderator of the service). In one arrangement, the identification server 140 is owned and operated by the entity operating the transaction processing server 108. In such an arrangement, the identification server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the identification server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for identifying one or more parking lots relative to a POI, such as permission to retrieve location information and probe data from the requestor device 102 and/or the provider device 104. Alternatively, another mobile device may be selected instead of the requestor device 102 and/or the provider device 104 for retrieving the data. Once on-boarded, the user would have a transaction account that stores all the details.

The requestor device 102 is associated with a customer (or requestor) who is a party to a transaction that occurs between the requestor device 102 and the provider device 104, or between the requestor device 102 and the identification server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a request for a ride or delivery.

The requestor device 102 includes transaction credentials (e.g., a payment account) of a requestor to enable the requestor device 102 to be a party to a payment transaction. If the requestor has a transaction account, the transaction account may also be included (i.e., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The customer uses the watch or similar wearable to make request regarding the transaction request by pressing a button on the watch or wearable.

The provider device 104 is associated with a provider who is also a party to the transaction request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a provider of a ride or delivery (e.g. a driver or deliverer responding to the request for the ride or delivery).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a travel co-ordinator or merchant) associated with the provider.

If the provider has a transaction account, the transaction account may also be included (i.e., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request or a request for a ride to the transaction processing server 108.

The transaction processing server 108 is configured to process processes relating to a transaction account by, for example, forwarding data and information associated with the transaction to the other servers in the system 100 such as the identification server 140. In an example, the transaction processing server 108 may, instead of the requestor device 102 or provider device 104, transmit data relating to a request message such as a request for a ride or delivery (e.g. date, time, a starting location, a destination location, and other similar data) to the identification server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g. a company or organization) which manages (e.g. establishes, administers) data relating to users, transactions, products, services, and other similar data, for example relating to the entity. In an arrangement, the reference database 150 may comprise data that is utilized by the identification server 140 for identifying one or more parking lots relative to a POI. For example, probe data obtained from one or more trip trajectories (e.g. each trip trajectory comprising movement along a route from a starting location to a destination location) in a road network and/or map may be processed and stored as data points in the reference database 150, wherein each trip trajectory may comprise a plurality of data points. Each data point represents a time instance of movement along a route, and may indicate a location (e.g. lat-lon coordinates), velocity, time-stamp, and other similar information relating to the time instance represented by the data point. The reference database 150 may also comprise data relating to maps (e.g. Karta Map™), as well as location information relating to POIs, geographical areas, buildings, road networks, previously identified parking lots, and other similar entities that may facilitate identifying one or more parking lots relative to a POI. In an implementation, the reference database 150 may be combined with the identification server 140. In an example, the reference database 150 may be managed by an external entity.

Advantageously, the system 100 advantageously enables identification of valid parking lot candidates that a driver or deliverer may use during a trip to/from a location. It also provides a measure of popularity of such parking lot candidates.

FIG. 2 illustrates a schematic diagram of an example identification server 140 according to various embodiments. The identification server 140 may comprise a data module 260 configured to receive data and information from the requestor device 102, provider device 104, transaction processing server 108, reference database 150, a cloud and other sources of information to identify one or more parking lots by the identification server 140. For example, the data module 260 may be configured to receive data and information required for processing probe data, data points, perform clustering, and other similar processes from the requestor device 102, the provider device 104, transaction processing server 108, reference database 150, and/or other sources of information. The data module 260 may be further configured to send information relating to data retrieved in response to the request for a ride or delivery to the requestor device 102, the provider device 104, the transaction processing server 108, or other destinations where the information is required.

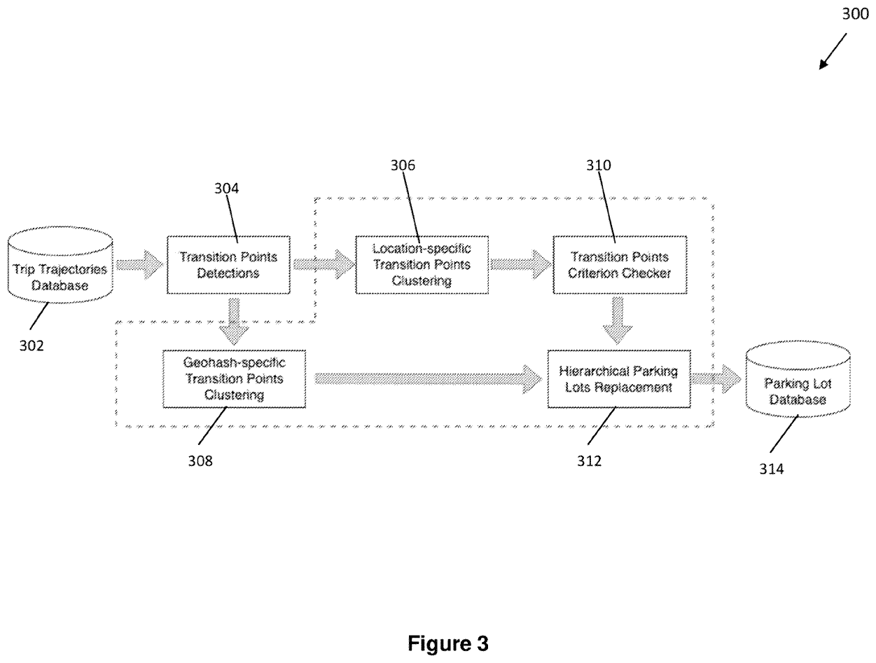

The identification server 140 may comprise a detection module 262 that is configured for detecting, from a plurality of data points, one or more data points that are indicative of a parking action in a parking lot, the plurality of data points representing movement along a route from a starting location to a destination location, each data point indicating a location. The detection process is further explained in FIG. 3.

The identification server 140 may also comprise an association module 264 that is configured for associating a first set of one or more of the detected data points with a POI based on a proximity of the indicated location of each of the one or more detected data points relative to a location of the POI, the POI being the starting location or the destination location, and associating a second set of one or more of the detected data points with one or more geographical areas in proximity with the POI, the association based on a proximity of the indicated location of each of the one or more detected data points relative to the one or more geographical areas. The association process is further explained in FIG. 3.

The identification server 140 may also comprise a clustering module 266 that is configured for grouping the first set of detected data points into a first set of one or more clusters and the second set of detected data points into a second set of one or more clusters, each cluster comprising one or more detected data points that are in proximity with one another. The clustering module 266 may be further configured for determining a centroid of each cluster, the centroid being a centre point of an associated cluster and indicative of a location of a parking lot. The clustering process is further explained in FIG. 3.

The identification server 140 may also comprise an identification module 268 that is configured for identifying one or more parking lots relative to the POI from the first or second set of detected data points based on a comparison of a number of the first set of detected data points with a threshold. The identification module 268 may be further configured for identifying a centroid of the first set of clusters or a centroid of the second set of clusters as the parking lot. The identification process is further explained in FIG. 3.

In an implementation, detecting the one or more data points may be based on determining one or more consecutive data points that are geospatially close to each other based on the indicated location.

In an implementation, each data point may represent a time instance of the movement along the route and further indicate a velocity of the represented time instance, and detecting the one or more data points may be based on determining one or more data points that correspond to a change of velocity based on the indicated velocity.

In an implementation, identifying the one or more parking lots by the identification module 268 may further comprise identifying the one or more centroids from the first set of clusters as the one or more parking lots when a number of the first set of detected data points exceeds the threshold.

In an implementation, identifying the one or more parking lots by the identification module 268 may further comprise identifying the one or more centroids from the second set of clusters as the parking lot when a number of the first set of detected data points is less than the threshold. The second set of detected data points may further comprise one or more other detected data points associated with one or more other POIs in proximity with the one or more geographical areas.

In an implementation, identifying the one or more centroids may be based on proximity of an indicated location of each of the one or more centroids with the POI.

Each of the data module 260, detection module 262, association module 264, clustering module 266 and identification module 268 may further be in communication with a processing module (not shown) of the identification server 140, for example for coordination of respective tasks and functions during the process. The data module 260 may be further configured to communicate with and store data and information for each of the processing module, detection module 262, association module 264, clustering module 266 and identification module 268. Alternatively, all the tasks and functions required for adaptively identifying one or more parking lots relative to a POI may be performed by a single processor of the identification server 140.

A trip trajectory of a vehicle within a road network may be defined as a sequence of GPS records (e.g. obtained from probe data), Tₓ=(x₁, x₂, x₃ . . . , xₙ), where x₁ denotes a record within the trajectory, and n denotes the total number of records in this trajectory. Each record xᵢ=(xᵢ.lat, xᵢ.lng, xᵢ.v), where xᵢ.lat, xᵢ.lng, xᵢ.v denote the latitude, the longitude, and the velocity, respectively. For each trajectory, it may be associated with a Ta, which is a set of attributes that provide more information about the trip and the vehicle(s) used in the trip. Vehicular attributes provide information about the vehicle that travels the trajectory, e.g., vehicle ID or vehicle type. The trip attributes may include information such as the starting location and destination location of the trip. More formally, a trajectory data instance may be defined which includes the trajectory and all its associated attributes, as T=(Tₓ, Tₐ). The objective of the solution is that given a dataset D of trajectory data instances, popular parking lots are detected specific to each location (e.g. POI) present in D that were used by drivers in the trips.

To this end, a novel solution is proposed that leverages on a multi-stage approach to detect one or more parking lots relative to a POI. The overview of this solution is shown in illustration 300 of FIG. 3. Transition points during a trip refer to points at which parking behavior is observed e.g. a parking action in a parking lot. There may be one or more probe trajectories that are stored in a trip trajectories database 302. The trip trajectories database 302 may be the reference database 150, or a part of the reference database 150. Each probe trajectory may comprise a plurality of data points, the plurality of data points representing movement along a route from a starting location to a destination location. Each data point may represent a time instance of the movement along the route and further indicate a location (e.g. lat-lon coordinates) and velocity of the represented time instance. In a first step 304, the solution is focused on detecting one or more transition points (e.g. detecting one or more data points that are indicative of a parking action in a parking lot) for each probe trajectory. This is done via the identification of predetermined trajectory subsequence patterns that are indicative of parking behavior.

There are many such candidate patterns that may be utilized, and one such pattern may be a set of consecutive trajectory points that are geospatially very close to each other. For example, detecting the one or more data points may be based on determining one or more consecutive data points that are geospatially close to each other based on the indicated location of each data point. Another such pattern looks like a sequence of points that can be broken down into two segments. The velocity values of the points within the first segment may be similar, but differ largely (much larger or much smaller) from those from the second segment. The idea is that travel speed is typically different for different vehicle mediums. E.g., walking/running tends to be way slower than bicycle travel. In this case, the transition point is the point in this sequence when the speed change is detected. For example, detecting the one or more data points may be based on determining one or more data points that correspond to a change of velocity based on the indicated velocity of each data point. All the trajectories in the dataset D are thus processed to get all the transition points within each trip, and denote the resulting dataset as S.

Each trajectory in D is typically associated with a starting location and a destination location that are POIs, e.g., shopping malls, residential estates. For each of these POIs, there is typically a unique identifier associated with it. Since the objective of the solution is to identify the parking lots that drivers popularly use to get to a POI, all the detected data points that are temporally closest to this POI during the trip are associated with this POI e.g. associating a first set of one or more of the detected data points with a POI based on a proximity of the indicated location of each of the one or more detected data points relative to a location of the POI, the POI being the starting location or the destination location. Doing so removes the parking point candidates that are not associated with the POIs. E.g., a driver may park the vehicle temporarily during the trip for fuel tank fillings in petrol stations.

Thereafter in a step 306, for each POI, clustering of the transition points associated with it may be performed e.g. grouping the first set of detected data points into a first set of one or more clusters, each cluster comprising one or more detected data points that are in proximity with one another; and determining a centroid of each cluster, the centroid being a centre point of an associated cluster and indicative of a location of a parking lot; and identifying one or more centroids of the first set of clusters as the one or more parking lots. Existing techniques for doing so include DBSCAN, K-means, etc. From the clustering, a set of one or more clusters and information for each cluster may be obtained, such as a centroid of each cluster, number of points in each cluster, etc. A parking lot candidate may then be inferred from each cluster, for example by taking the centroid of that cluster. As such, a list of inferred parking lots may be obtained for each POI. The dataset that contains the POI to parking lots mapping may be denoted as P.

In a similar way, a geohash-specific transition point clustering may be performed in a step 308. Specifically, for each geohash, clustering may be performed on the transition points that are associated with the POIs that fall within that geohash. Then, the parking lots are inferred based on the centroids of these clusters e.g. associating a second set of one or more of the detected data points with one or more geographical areas in proximity with the POI, the association based on a proximity of the indicated location of each of the one or more detected data points relative to the one or more geographical areas; grouping the second set of detected data points into a second set of one or more clusters, each cluster comprising one or more detected data points that are in proximity with one another; determining a centroid of each cluster, the centroid being a centre point of an associated cluster and indicative of a location of a parking lot; and identifying one or more centroids of the second set of clusters as the one or more parking lots. As such, for each geohash, a list of inferred parking lots may be obtained. The dataset that contains all the geohash parking lots may be denoted as G.

If the dataset is small, it is likely that the number of transition points per POI is sparse. As a result, the sizes of the clusters may be small, and the parking lots inferred may not be as reliable. To resolve this, in a step 310, parking lot replacement may be performed for the POIs which have a number of transition points that is below a certain threshold. The key idea in Transition-points Criterion Checker is that for each POI in P, we first check if this POI has at least one parking lot inferred from a cluster of size larger than a threshold, k. If this condition is not met, in a step 312, a Hierarchical Parking Lot

Replacement may be performed for this POI. The key idea is that dataset G is first checked to see if there is at least an inferred parking lot associated with the geohash that this POI is on, and if they are based on clusters of sizes larger than k. If this condition is also not met, G is checked again to see if such parking lots exist in the geohashes adjacent to this geohash. If a parking lot is found in any of these steps, the existing POI's parking lot may be replaced with that of the geohash's instead e.g. identifying a parking lot relative to the POI from the first or second set of detected data points based on a comparison of a number of the first set of detected data points with a threshold. Thereafter, the identified parking lots are then stored in a parking lot database 314. The parking lot database 314 may be the reference database 150, or a part of the reference database 150. In an implementation, information of these identified parking lots may then be provided to the requestor device 102 or provider device 104 for a ride or delivery request (e.g. informing the driver of possible parking lot locations that the driver can use when he or she arrives at the destination location), or provided as a separate service in response to an enquiry to locate available parking lots relating to a POI or a geographical area.

The rationale behind this approach is that POIs that fall within the same geohash area are likely to share the same parking lots, so long as the geohash remains fine-grained, e.g., geohash level 8 which is almost an area of a building. Similarly, this may apply to POIs of neighbouring geohashes as well. For example, shop houses along a segment of a street/residential area may often share the same parking lots as that of the other segment of the same street/area. As such, the hierarchical replacement approach advantageously enables substitution of low-confidence POI-specific parking lots (e.g. inferred parking lots from the first set of detected data points wherein the cluster size is lesser than the threshold) with higher-confidence ones from the geohashes (e.g. inferred parking lots from the second set of detected data points).

The current solution seeks to find popular parking lots based on trips that begin or end with specific POIs. In an implementation, a variation would be to find popular parking lots based on the trips that begin or end with the building that the POI is in. A benefit of this variation is that this would reduce the number of duplicate parking lots detected. For example, it is likely that two POIs within the same mall may share the same parking lots. Furthermore, since the transition points are aggregated on the building level, the solution would be less severely impacted by data sparsity. Of course, the flipside would happen on the edge cases such as one where a mall has multiple parking lots. In such a case, one parking lot may sometimes be more preferable than another for getting to a particular POI.

Building-level parking lot dataset may also be applied to the Hierarchical Parking Lot Replacement stage 312. For example, instead of falling back directly to the parking lots at the geohash-level in cases of data sparsity, it is possible to fall back to the parking lots associated with the neighbouring buildings.

In another variation, street-level parking lot detection may be utilized. This variation is similar to building-specific parking lots detection and seeks to reduce the number of duplicate parking lots. The difference is that instead of performing clustering of transition points specific to a building, clustering specific to the street nearest to the POI is performed. This approach is expected to perform better in comparison to the building-specific parking lots detection described above for example in areas where buildings are mostly dispersed and small (e.g., POIs are mostly in shop houses or house-like structures). In contrast, building-specific parking lots detection intuitively works well in places where POIs are often concentrated within a single building, such as metropolitan areas.

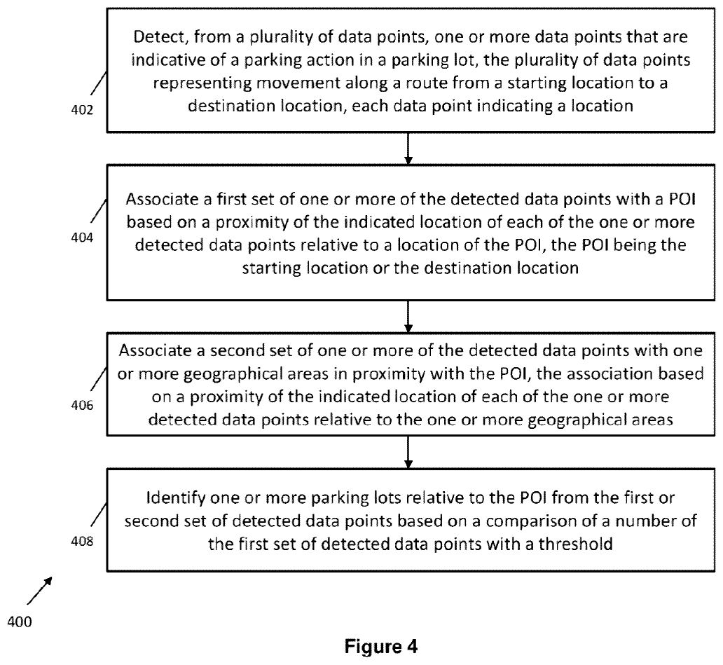

FIG. 4 illustrates an example flow diagram of a method 400 for identifying one or more parking lots relative to a POI according to various embodiments. In a step 402, one or more data points that are indicative of a parking action in a parking lot are detected from a plurality of data points, the plurality of data points representing movement along a route from a starting location to a destination location, each data point indicating a location. In a step 404, a first set of one or more of the detected data points are associated with a POI based on a proximity of the indicated location of each of the one or more detected data points relative to a location of the POI, the POI being the starting location or the destination location. In a step 406, a second set of one or more of the detected data points are associated with one or more geographical areas in proximity with the POI, the association based on a proximity of the indicated location of each of the one or more detected data points relative to the one or more geographical areas. In a step 408, one or more parking lots relative to the POI are identified from the first or second set of detected data points based on a comparison of a number of the first set of detected data points with a threshold.

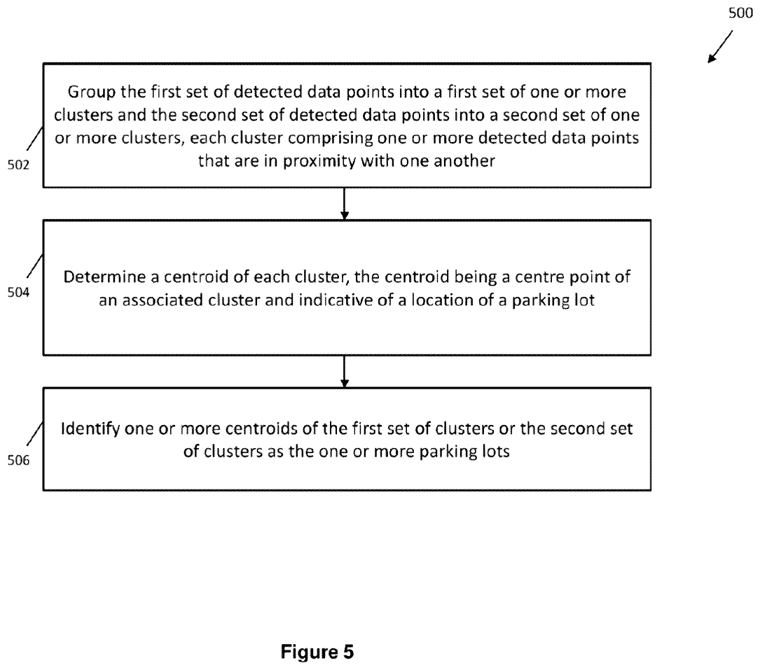

FIG. 5 illustrates an example flow diagram for a clustering method 500 according to various embodiments. In a step 502, the first set of detected data points are grouped into a first set of one or more clusters and the second set of detected data points are grouped into a second set of one or more clusters, each cluster comprising one or more detected data points that are in proximity with one another. In a step 504, a centroid of each cluster is determined, the centroid being a centre point of an associated cluster and indicative of a location of a parking lot. In a step 506, one or more centroids of the first set of clusters or the second set of clusters are identified as the one or more parking lots.

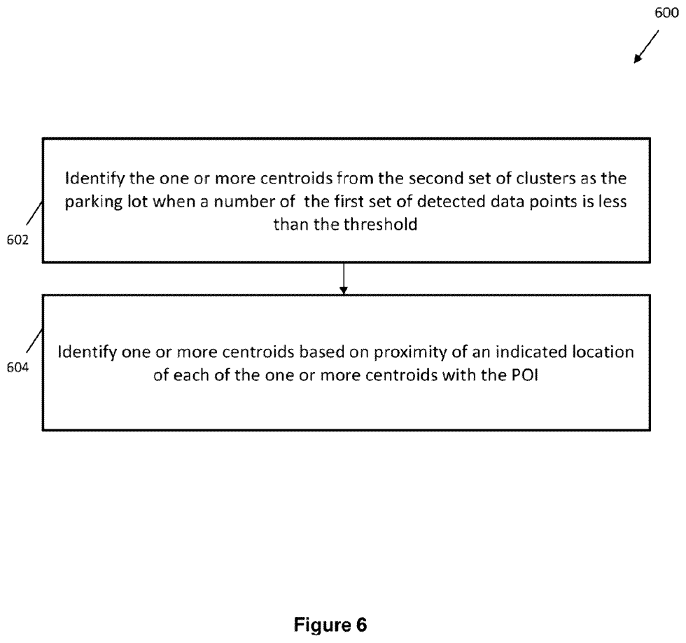

FIG. 6 illustrates an example flow diagram for a method 600 for identifying one or more centroids relative to a POI according to an embodiment. In a step 602, one or more centroids from the second set of clusters are identified as the one or more parking lots when a number of the first set of detected data points is less than the threshold. In a step 604, the one or more centroids are identified based on proximity of an indicated location of each of the one or more centroids with the POI.

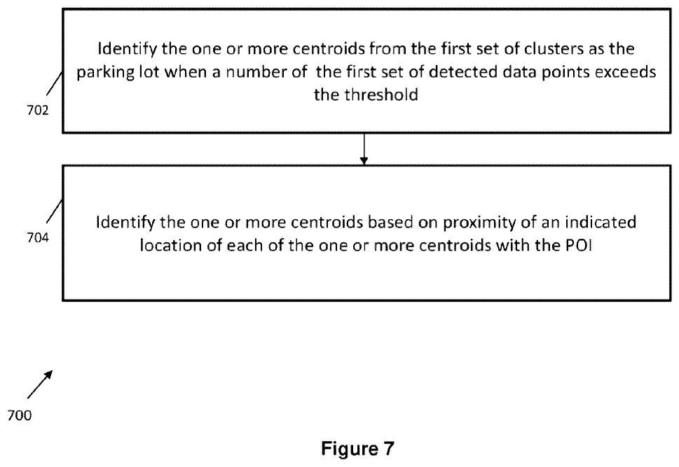

FIG. 7 illustrates an example flow diagram for a method 700 for identifying one or more centroids relative to a POI according to another embodiment. In a step 702, the one or more centroids from the first set of clusters are identified as the parking lot when a number of the first set of detected data points exceeds the threshold. In a step 704, the one or more centroids are identified based on proximity of an indicated location of each of the one or more centroids with the POI.

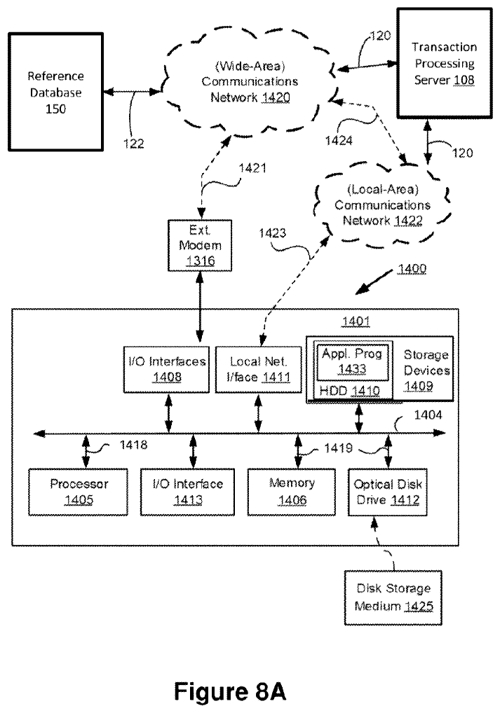

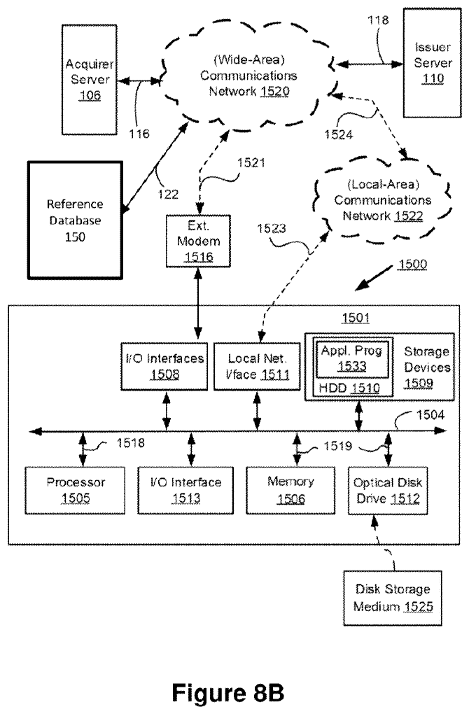

FIG. 8A depict an example computer system 1400, in accordance with which the identification server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun

The methods 400, 500, 600 and 700 (e.g. methods 400-700), where performed by the identification server 140 may be implemented using the computer system 1400. The processes may be implemented as one or more software application programs 1433 executable within the computer system 1400. In particular, the methods 400-700 are effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 700 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for an identification server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for an identification server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the identification server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

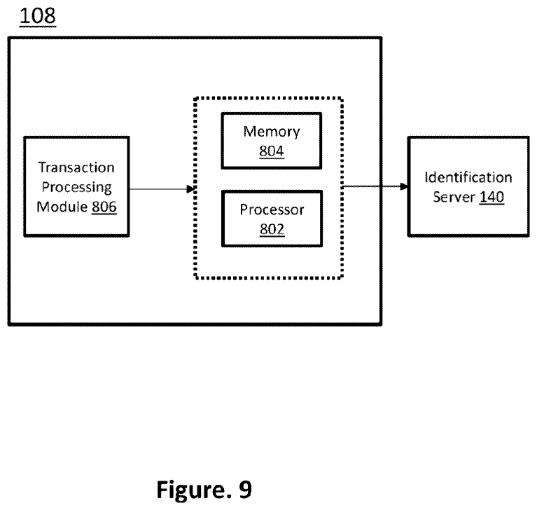

FIG. 9 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in methods 400-700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, a request for a ride or delivery, or other similar messages. The transaction processing module 806 may be configured to process processes relating to a transaction account by, for example, forwarding data and information associated with the transaction to the other servers in the system 100 such as the identification server 140. For example, data relating to a request message such as a request for a ride (e.g. date, time, a starting location, a destination location, and other similar data) may be provided to the identification server and processed to locate drivers (e.g. ride providers) that are in proximity to the starting location. The transaction processing server may use a variety of different protocols and procedures in order to process the payment and/or travel co-ordination requests.

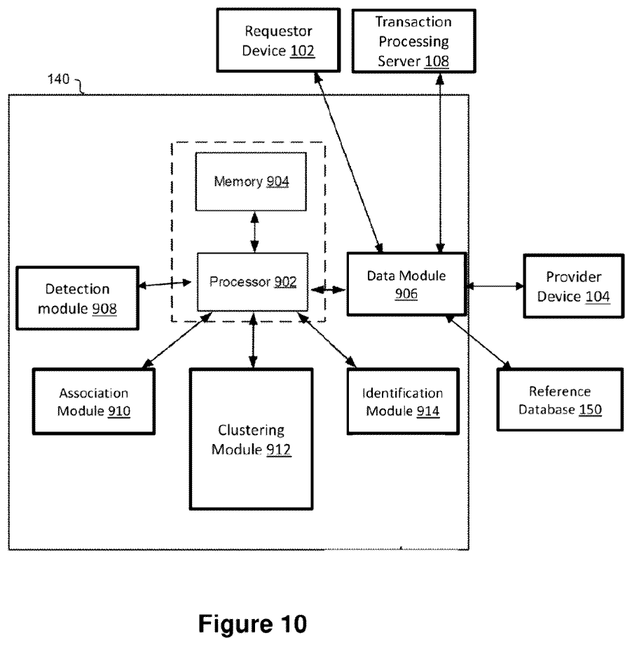

FIG. 10 shows an alternative implementation of the identification server 140 (i.e., the computer system 1400). In the alternative implementation, identification server 140 may be generally described as a physical device comprising at least one processor 902 and at least one memory 904 including computer program codes. The at least one memory 904 and the computer program codes are configured to, with the at least one processor 902, cause the identification server 140 to perform the operations described in the methods 400-700. The identification server 140 may also include a data module 906, a detection module 908, an association module 910, a clustering module 912 and an identification module 914. The memory 904 stores computer program code that the processor 902 compiles to have each of the modules 906 to 914 performs their respective functions.

With reference to FIGS. 1 to 7, the detection module 908 performs the function of detecting, from a plurality of data points, one or more data points that are indicative of a parking action in a parking lot, the plurality of data points representing movement along a route from a starting location to a destination location, each data point indicating a location.

With reference to FIGS. 1 to 7, the association module 910 performs the function of associating a first set of one or more of the detected data points with a POI based on a proximity of the indicated location of each of the one or more detected data points relative to a location of the POI, the POI being the starting location or the destination location, and associating a second set of one or more of the detected data points with one or more geographical areas in proximity with the POI, the association based on a proximity of the indicated location of each of the one or more detected data points relative to the one or more geographical areas.

With reference to FIGS. 1 to 7, the clustering module 912 performs the function of grouping the first set of detected data points into a first set of one or more clusters and the second set of detected data points into a second set of one or more clusters, each cluster comprising one or more detected data points that are in proximity with one another. The clustering module 912 may be further configured for determining a centroid of each cluster, the centroid being a centre point of an associated cluster and indicative of a location of a parking lot.

With reference to FIGS. 1 to 7, the identification module 914 performs the function of identifying one or more parking lots relative to the POI from the first or second set of detected data points based on a comparison of a number of the first set of detected data points with a threshold. The identification module 914 may be further configured for identifying one or more centroids of the first set of clusters or one or more centroids of the second set of clusters as the one or more parking lots.

In an implementation, detecting the one or more data points may be based on determining one or more consecutive data points that are geospatially close to each other based on the indicated location.

In an implementation, each data point may represent a time instance of the movement along the route and further indicate a velocity of the represented time instance, and detecting the one or more data points may be based on determining one or more data points that correspond to a change of velocity based on the indicated velocity.

In an implementation, identifying the one or more parking lots by the identification module 914 may further comprise identifying the one or more centroids from the first set of clusters as the one or more parking lots when a number of the first set of detected data points exceeds the threshold.

In an implementation, identifying the one or more parking lots by the identification module 914 may further comprise identifying the one or more centroids from the second set of clusters as the one or more parking lots when a number of the first set of detected data points is less than the threshold. The second set of detected data points may further comprise one or more other detected data points associated with one or more other POIs in proximity with the one or more geographical areas.

In an implementation, identifying the one or more centroids may be based on proximity of an indicated location of each of the one or more centroids with the POI.

With reference to FIGS. 1 to 7, the data module 906 performs the functions of receiving data and information from the requestor device 102, provider device 104, transaction processing server 108, reference database 150, a cloud and other sources of information to facilitate the methods 600-700. For example, the data module 906 may be configured to receive data and information required for processing probe data, data points, perform clustering, and other similar processes from the requestor device 102, the provider device 104, transaction processing server 108, reference database 150, and/or other sources of information. The data module 906 may be further configured to send information relating to data retrieved in response to the request for a ride or delivery to the requestor device 102, the provider device 104, the transaction processing server 108, or other destinations where the information is required.

FIG. 8B depicts a general-purpose computer system 1500, upon which a combined transaction processing server 108 and identification server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun

The steps of the methods 400-700 performed by the identification server 140 and facilitated by the transaction processing server 108 may be implemented using the computer system 1500. For example, the steps of the methods 400-700 as performed by the identification server 140 may be implemented as one or more software application programs 1533 executable within the computer system 1500. In particular, the steps of the methods 400-700 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the methods 400-700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and identification server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and identification server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined transaction processing and identification server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

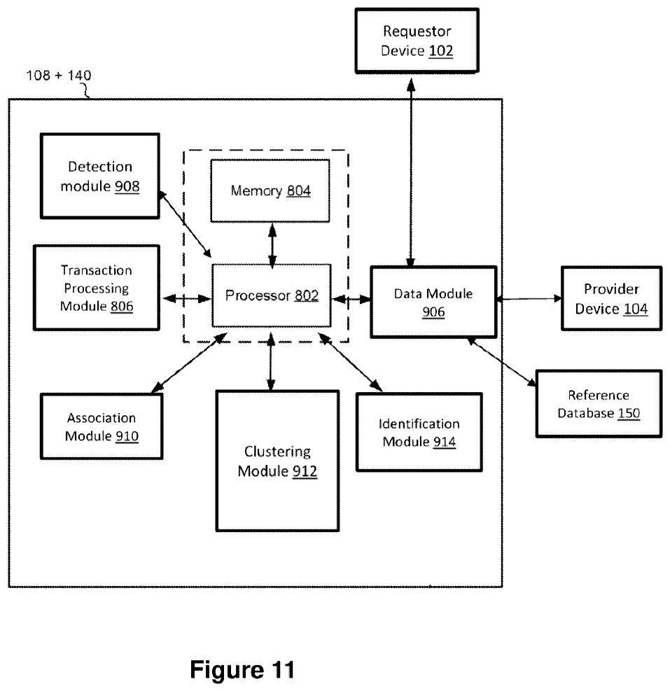

FIG. 11 shows an alternative implementation of combined transaction processing and identification server (i.e., the computer system 1500). In the alternative implementation, the combined transaction processing and identification server may be generally described as a physical device comprising at least one processor 1002 and at least one memory 904 including computer program codes. The at least one memory 1004 and the computer program codes are configured to, with the at least one processor 1002, cause the combined transaction processing and identification server to perform the operations described in the steps of the methods 400-700. The combined transaction processing and identification server may also include a transaction processing module 806, a data module 906, a detection module 908, an association module 910, a clustering module 912 and an identification module 914. The memory 1004 stores computer program code that the processor 1002 compiles to have each of the modules 806 to 912 performs their respective functions. The transaction processing module 806 performs the same functions as described for the same transaction processing module in FIG. 9. The data module 906, detection module 908, association module 910, clustering module 912 and identification module 914 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

1. A method for identifying one or more parking lots relative to a point of interest (POI); comprising:
detecting, from a plurality of data points, one or more data points that are indicative of a parking action in a parking lot, the plurality of data points representing movement along a route from a starting location to a destination location, each data point indicating a location;
associating a first set of one or more of the detected data points with a POI based on a proximity of the indicated location of each of the one or more detected data points relative to a location of the POI, the POI being the starting location or the destination location;
associating a second set of one or more of the detected data points with one or more geographical areas in proximity with the POI, the association based on a proximity of the indicated location of each of the one or more detected data points relative to the one or more geographical areas; and
identifying the one or more parking lots relative to the POI from the first or second set of detected data points based on a comparison of a number of the first set of detected data points with a threshold.

2. The method of claim 1. wherein detecting the one or more data points is based on determining one or more consecutive data points that are geospatially close to each other based on the indicated location.

3. The method of claim 1, wherein each data point represents a time instance of the movement along the route and further indicates a velocity of the represented time instance, and detecting the one or more data points is based on determining one or more data points that correspond to a change of velocity based on the indicated velocity.

4. The method of claim 1, wherein identifying the one or more parking lots further comprises:
grouping the first set of detected data points into a first set of one or more clusters and the second set of detected data points into a second set of one or more clusters, each cluster comprising one or more detected data points that are in proximity with one another;
determining a centroid of each cluster, the centroid being a centre point of an associated cluster and indicative of a location of a parking lot; and
identifying one or more centroids of the first set of clusters or one or more centroids of the second set of clusters as the one or more parking lots.

5. The method of claim 4, further comprising identifying the one or more centroids from the first set of clusters as the one or more parking lots when a number of the first set of detected data points exceeds the threshold.

6. The method of claim 4, further comprising identifying the one or more centroids from the second set of clusters as the one or more parking lots when a number of the first set of detected data points is less than the threshold.

7. The method of claim 6, wherein the second set of detected data points further comprises one or more other detected data points associated with one or more other POIs in proximity with the one or more geographical areas.

8. The method of claim 4, wherein identifying the one or more centroids is based on proximity of an indicated location of each of the one or more centroids with the POI.

9. A system for identifying one or more parking lots relative to a point of interest (POI): comprising:
at least one processor; and
at least one memory including computer program code:
the at least one memory and the computer program code configured to, with the at least one processor, cause the system at least to:
detect, from a plurality of data points, one or more data points that are indicative of a parking action in a parking lot, the plurality of data points representing movement along a route from a starting location to a destination location, each data point indicating a location;
associate a first set of one or more of the detected data points with a POI based on a proximity of the indicated location of each of the one or more detected data points relative to a location of the POI, the POI being the starting location or the destination location;
associate a second set of one or more of the detected data points with one or more geographical areas in proximity with the POI, the association based on a
proximity of the indicated location of each of the one or more detected data points relative to the one or more geographical areas; and
identify the one or more parking lots relative to the POI from the first or second set of detected data points based on a comparison of a number of the first set of detected data points with a threshold.

10. The system of claim 9, wherein detecting the one or more data points is based on determining one or more consecutive data points that are geospatially close to each other based on the indicated location.

11. The system of claim 9, wherein each data point represents a time instance of the movement along the route and further indicates a velocity of the represented time instance, and detecting the one or more data points is based on determining one or more data points that correspond to a change of velocity based on the indicated velocity.

12. The system of claim 9, wherein identifying the one or more parking lots further comprises:
grouping the first set of detected data points into a first set of one or more clusters and the second set of detected data points into a second set of one or more clusters, each cluster comprising one or more detected data points that are in proximity with one another;
determining a centroid of each cluster, the centroid being a centre point of an associated cluster and indicative of a location of a parking lot; and
identifying one or more centroids of the first set of clusters or one or more centroids of the second set of clusters as the one or more parking lots.

13. The system of claim 12, further configured to identify the one or more centroids from the first set of clusters as the one or more parking lots when a number of the first set of detected data points exceeds the threshold.

14. The system of claim 12, further configured to identify the one or more centroids from the second set of clusters as the one or more parking lots when a number of the first set of detected data points is less than the threshold.

15. The system of claim 14, wherein the second set of detected data points further comprises one or more other detected data points associated with one or more other POIs in proximity with the one or more geographical areas.

16. The system of claim 12, wherein identifying the one or more centroids is based on proximity of an indicated location of each of the one or more centroids with the POI.
